(19) United States
(12) Patent Application Publication
(10) Pub. No.: US 2002/0049505 A1
(43) Pub. Date: Apr. 25, 2002

(54) Power section for driving an electric drive, a drive control based thereon, and a method for networking a control unit with one or more power sections

(76) Inventors: Gerhard Heinemann, Erlangen (DE); Joachim Parsch, Nuernberg (DE); Alexander Wagenpfeil, Roettenbach (DE)

Correspondence Address: BAKER & BOTTS, 30 ROCKEFELLER PLAZA, NEW YORK, NY, 10112

(21) Appl. No.: 09/919,540

(22) Filed: Jul. 31, 2001

(30) Foreign Application Priority Data
Sep. 27, 2000 (DE) 100 479 27.8

(51) Int. Cl. G05B 11/01

(52) U.S. Cl. 700/22; 700/2; 700/3

(57) ABSTRACT

By distributing the intelligence of a drive between a control unit and one or more intelligent power sections by using a high-power standardized serial interface for connecting these components, it is possible as a result to identify different power components with their performance data, and also to diagnose them. Furthermore, independent innovations of the components are possible without having corresponding effects on the other components.

### FIELD OF THE INVENTION

The invention relates to a power section for driving a device and more particularly to a drive control based on a power section for driving an electric drive and a method for networking a control unit with one or more power sections.

### BACKGROUND OF THE INVENTION

In previously known drive controls, an exchange of information takes place between the controlling intelligence, for example, a drive processor, and the passive power sections through what is termed a pulse interface. There is so far no standard for this pulse interface, and it can for the most part not even be freely exchanged within the individual drive developments of a manufacturer.

The task of the control (in addition to the actual control algorithms and the drive functionality) consists first in optimal preparation of the drive pulses of the power section transistors. It is conventional for this purpose to connect downstream of the current regulator output on the control side, a control unit which converts desired voltage values, which are usually present as the absolute value and phase of the voltage, or as phase voltages, into inverter signals through a pulse or sampling triangle (asynchronous control unit). The control unit alternatively calculates synchronous pulse patterns from the desired voltage values (edge modulation, optimized pulse patterns).

Conventionally, actual current values are transferred on the actual-value side as load voltages to the control module. The acceptance of the measured values (that is to say the standardization and accounting of the hardware-specific properties) is performed in this case in a complicated fashion on the control processor. Specific parameters have to be stored for each converter in the control software. Since the type of power section sometimes cannot be detected automatically by the software, the system startup engineer frequently has to input the type by hand. This signifies additional outlay and costs. Moreover, faulty settings can occur as a result of this manual output.

For reasons of cost, the pulse interface in the previous systems constitutes a communication bottleneck. A definition of the interface allocation is performed in this case as largely as possible from functional points of view at the expense of diagnostic requirements.

### SUMMARY OF THE INVENTION

It is therefore the object of the present invention to create a link between a power controller and a control in time with the current regulator, a standardized communication being rendered possible between the individual components.

In accordance with the present invention this object is achieved by providing a method for networking a control unit with one or more power sections, including: splitting up the computing capacity of a drive control between an electronic control system and an assigned power section; connecting the control unit and each power section through a digital interface with real-time capability; and synchronizing the communication between the control unit and each power section by means of a digital transmission protocol.

Preferably, the desired digital voltage values determined in the control unit are transferred to the respective power section through the digital interface; drive pulses for the motor to be controlled are determined in the respective power section; respective actual phase current values of the motor to be controlled are detected in the respective power section; and these actual phase current values are transferred to the control unit by the respective power section through the digital interface synchronously with the control clock.

Moreover, a complete identification of the components can be achieved by means of a central control entity by virtue of the fact that in an initialization phase for each power section of the control unit the digital interface is used to transmit a respective unique characteristic value with the aid of which the control unit identifies and/or parameterizes the respective power section. Preferably, the digital interface is implemented as a bi-directional serial data transmission, resulting in a particularly low outlay during implementation.

In a preferred embodiment of the present invention, there is provided a power section for driving an electric drive including: power converter valves for generating phase currents for a connected electric drive; computers for generating drive signals for the power converter valves; a detector detecting actual phase current values and for digitizing the detected actual current values, digitization being performed in the computing means, in particular; and a synchronous interface for transmitting digital actual phase current values to a superordinate processing unit and for receiving digital desired voltage values for generating corresponding drive signals in the computer. Preferably, the synchronous interface is configured as a bus system in order to implement a larger drive assembly, in particular for the coupling of a plurality of devices. The power converter valves can be configured as a transistor bridge, in particular as a three-phase bridge connection, when the power section is configured as a converter or inverter.

The power section preferrably includes an identification means by which it is possible to provide a characteristic value for unique identification of the power section through the synchronous interface. Thus it is possible to achieve a complete identification of the power components by a central control entity, the identification means advantageously being configured as a nonvolatile memory which contains the unique characteristic value.

According to a further preferred embodiment of the power section according to the present invention, the power section has a detector for detecting actual temperature values of the power section and for digitizing the detected actual temperature values, digitization being performed, in particular, in the computing means. The synchronous interface serves the purpose of transmitting the digital actual temperature values to a superordinate processing unit. Each power section preferrably transmits a respective unique characteristic value to the control unit in an initialization phase through the digital interface. The synchronous interface is preferably configured as a communication system which has a master-slave structure and in which the control unit is a master and the power section is a slave.

What is termed an “electronic shaft” can thereby be formed with a plurality of converters in a way which is cost effective and particularly simple, by virtue of the fact that a control unit as master drives a plurality of power sections as slaves via the synchronous communication system synchronously with a uniform current regulator clock.

Additional advantages can be achieved, inter alia, by decentralizing the intelligence, that is to say power sections lose their passive character and acquire their own intelligence in the form of a microprocessor. The interface between the components can be standardized. The individual components can undergo innovation or be expanded separately taking account of the definition of the interface. Conformance with the various power section requirements (for example for machine tools and production machines with a power of 0.5 kW to approximately 120 kW, for large scale drives and installations with a power of 50 kW to approximately 10 MW) is rendered possible. Optional structures are supported optimally thereby. The number of power sections which can be connected is flexible because there is no need for any hardware elements specific to power section to be present on the central control entity, and the serial interface can operate a logic bus. It is no longer necessary to hold any lists with power section data in software of the control module. Customer-specific power sections can thereby be operated without compatibility problems. There is synchronization of the communication links in hardware, (with regard to timing ratios, equidistance etc.) and software (with regard to protocol contents), and this renders possible, for example interpolating axes with comparable dynamics as far as into the current regulator region; implementation of an “electronic shaft” by synchronizing a plurality of converters; and parallel connection of power sections with comparable dynamics of the individual actuators.

### BRIEF DESCRIPTION OF THE DRAWINGS

For a more complete understanding of the present invention and its advantages, reference is now made to the following description, taken in conjunction with the accompanying drawings, in which:

FIG. 1 shows an example of a topology with a control unit and a plurality of power sections by networking according to the invention; and

FIG. 2 shows a block diagram of a drive control according to the invention and having a power section according to the invention.

Throughout the figures, unless otherwise stated, the same reference numerals and characters are used to denote like features, elements, components, or portions of the illustrated embodiments. Moreover, while the subject invention will now be described in detail with reference to the figures, and in connection with the illustrative embodiments, changes and modifications can be made to the described embodiments without departing from the true scope and spirit of the subject invention as defined by the appended claims.

### DETAILED DESCRIPTION OF THE INVENTION

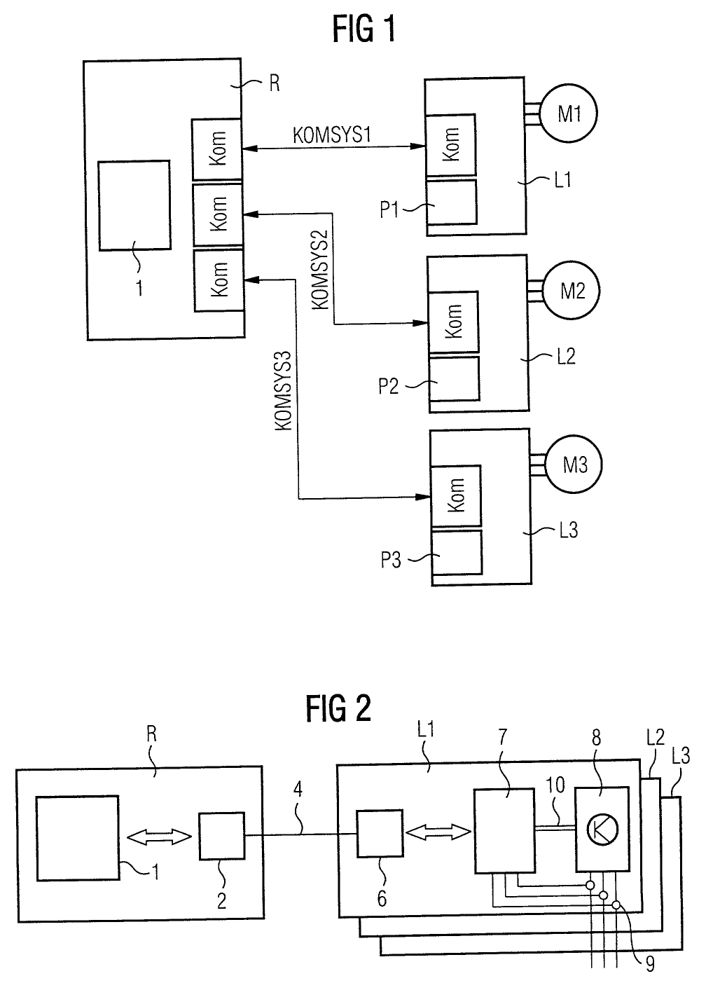

FIG. 1 illustrates a communication network with three different communication systems KOMSYS1, KOMSYS2, KOMSYS3 through which power sections L1, L2, L3 assigned to the motors M1, M2, M3, respectively, communicate with a superordinate control unit R. The arrangement shown can, for example, be three coupled drives of an industrial processing machine, a machine tool or a robot.

Shifting the computing capacity from the control unit R to the power sections L1, L2, L3 is possible by using a high-performance synchronous transmission system KOMSYS1, KOMSYS2, KOMSYS3. The control unit R contains a control processor 1, while the power sections L1, L2, L3 contain additional microprocessors or microcontrollers P1, P2, P3, respectively.

The control unit R contains a communication module Kom 102, a communication module Kom 104, and a communication module Kom 106. The power sections L1, L2, L3, each contain a communication module Kom 108, 110, 112, respectively, which allow the power sections L1, L2, L3, to be connected to the control unit R. In an alternate embodiment, a bus structure can be used through which the communication is performed.

The control unit R and the power sections L1, L2, L3 can each have one or more communication modules Kom, allowing for the networking of a plurality of components. The communication link can thereby be extended to further participants. The communication modules Kom 102, 104, 106, 108, 110, 112 process the digital transmission protocol. The digital transmission protocol allows bi-directional communication between the control unit R and the power sections L1, L2, L3. Bi-directional communication makes it possible for the power sections L1, L2, L3 to supply the control unit R with the required actual phase current values in time with the current regulator, and for the control unit R to supply the power sections L1, L2, L3 with desired voltage values, likewise in time with the control clock.

An example of such a suitable synchronous transmission system with real-time capability is a communication network based on an Ethernet connections. The Ethernet connections are enhanced to form a deterministic transmission system through a suitable digital transmission protocol.

The standardized transmission layer 2, i.e. message frame and access method, of the fast Ethernet is redefined by a new data protocol and a new access control system to comply with the requirements of real-time transmissions and the high level of reliability in transmission of data. Communication can thereby be implemented between the control unit R and the power sections L1, L2, L3.

With reference to synchronization between a master, for example the control unit R, and slave units, for example, the power sections L1, L2, L3, it proves to be advantageous when the slave units are synchronized to the master unit. Each slave unit is clocked, through a respective time counter, which is clocked with a prescribed total cycle time and is set cyclically by a certain item or message of slave-specific synchronization information determined by the master unit.

A master-slave communication architecture is therefore employed. In order to be able to implement cyclic data exchange with identical sampling instants, a common time base is produced for the master unit and all the slave units. The synchronization of the slave units to the master unit is performed by specifically marked, temporally defined messages from the master to the slaves and individually configured time counters in the slaves.

Useful data messages and specific synchronization messages can be transmitted, which contain the respective synchronization information. Alternatively, the synchronization information can be integrated in a marked useful data message.

The stability of the communication system can be increased if each timer counter of a slave unit independently and automatically starts a new cycle after the expiration of the predefined overall cycle time, even when the respective synchronization information is missing.

A time-slot access method, which is initialized by the master unit in the network, permits data to be transmitted optimally in terms of dead time, and can be, for example, used to the transmit and receive modes for cyclic data transmission. The messages can thereby be monitored precisely for a disturbed, premature or delayed transmission.

For the purpose of initializing the time-slot access method, only the master unit has transmission authorization on the communication link. The master unit sends each slave unit (which exclusively has response authorization) a corresponding slave-specific message which contains the total cycle time, the time slots within which the respective slave unit is to receive messages from the master unit, and the time slots within which the respective slave unit is to send its messages. In a preferred embodiment, each slave unit is informed of the respective synchronization time in the initialization phase.

Simultaneous and equidistant sampling can be achieved for the control unit R when in each slave unit, i.e. the power sections L1, L2, L3, instantaneous values, for example, actual phase current values of a connected motor M1, M2, M3, and the like, are stored at a common time. In an example of this embodiment, the common time is at the start of a cycle. Further, each message transmitted by the master unit to a slave unit may contain control information which may activate safety-oriented functions provided directly in the slave unit can be activated. The useful data can be transported in a message frame which, in addition to slave addressing and message length information, provides for data integrity to be detected by means, for example, of a cyclic redundancy checksum, and makes available further safety-relevant data areas. The data in the message frames can be used not only by an application processor, but also by a communication module KOM.

It has been found to be advantageous of each slave unit emits a signal to the master unit with each message. If this signal is absent, the master unit stops the appropriate slave unit in a controlled manner.

Although the transmission technology applied in accordance with the Ethernet standard permits only point-to-point connections, it is possible, as in the case of fast Ethernet networks, to facilitate the formation of networks through the use of network nodes (HUBs) by virtue of the fact that a plurality of communication participants or each communication participant has a circuit section for forming network nodes which serves the purpose of relaying the messages in the direction of another master unit or further slave units. Additionally, communication between communication participants taking place through network nodes is likewise in accordance with the procedure described above.

With the aid of the procedure described above, real-time communication can be achieved on the basis of a communication system based on Ethernet connections. In this case, hierarchical networks with point-to-point connections, connected through network nodes, can be set up in relatively large network topologies in order to carry out real-time communication. This is also suitable for networking or coupling a distributed drive system by virtue of the fact that a control unit R serves as the master unit of a communication system KOMSYS1, KOMSYS2 or KOMSYS3, which has an assigned power section L1, L2, L3 as a slave unit.

Extremely time-critical applications with a high frequency control clock can be implemented by virtue of the fact that communication between the drive components, such as, control unit R, power sections L1, L2, L3, and further components such as transmitter systems and motion controls, is upgraded to real-time capability by an existing high-performance transmission system which utilizes master-slave synchronization and time slot access methods.

Assuming that the transmission bandwidth ensures communication in time with the current regulator, communication networks other than that described above by way of example may be used to implement the communication network between the power sections L1, L2, L3 and the control unit R.

FIG. 2 illustrates a block diagram of the power section L1, and its communication with a control unit R. The control unit R includes a control processor or drive processor 1 and a communication module Kom 2. The control unit R sends and receives data through the communication module Kom 2, which functions as driver module of the control unit R. The communication module Kom 2 processes the digital transmission protocol for sending and receiving data. The digital transmission protocol can be the previously described transmission protocol based on an Ethernet connections.

The power section L1 of the three power sections L1, L2, L3 in FIG. 1 includes a microprocessor 7, a communication module 6, a power converter valves 8, and an actual current value detection unit 9. The microprocessor 7, which is the same as the microprocessor P1 of FIG. 1, is advantageously configured as a microcontroller and therefore contains interfaces and, if appropriate, an analog-to-digital converter. This microcontroller 7 likewise accesses the communication module 6, which is the same as the communication module Kom 108 of FIG. 1, which communicates with the communication module 2 of the control unit R. The communication module 2 of the control unit R, and the communication module 6 of the power section L1 are connected by a communication link 4, for example the communication system KOMSYS1 shown in FIG. 1. The communication module 2 of the control unit R and the communication module 6 of the power section L1 communicate using the digital transmission protocol.

Desired digital voltage values are transferred from the communication module 2 of the control unit R to the communication module 6 of the power section L1 through the connection 4. The microcontroller 7 of the power section L1 optimizes drive pulses 10 to the existing type of power section and generates the drive signals 10. The drive signals 10 are optimized specifically for the power section and the power converter valves 8. The power converter valves 8 can be a 6-phase transistor bridge.

This yields the following further advantages, inter alia: adaptations to new transistor technologies, i.e. components, second sources, dead times, can be minimized and are possible without affecting the control, parallel circuits can be achieved by multiplying the control logic. Complex drive methods can be introduced more easily, for example independent further rotation of the voltage space vector given knowledge of the amplitude, the starting angle and, in addition, an electric rate of rotation derived from the rotational speed, thus reducing the pressure on unrealistically small current regulator clock pulses in conjunction with fast-revving motors. The drive logic can be loaded with new software independently of the connected power section.

An actual current value detection unit 9 transmits the actual phase current values determined by the power converter valves 8 to the microcontroller 7. The microcontroller 7 digitizes the actual phase current values. The microcontroller 7 can use the integrated analog-to-digital converter to perform the conversion. The same can be implemented for an actual temperature value detection unit (not shown). The microcontroller 7 transmits the digital actual phase current values of the connected motor and the actual temperature values, if the actual temperature values were determined for the power section, to the control unit R through the communication module 6, the communications link 4, and the communication module 2.

The following further advantages can thereby be achieved: measurement methods can be changed without affecting the control algorithm; acceptance and conversion of the measured values is performed as a function of the hardware implementation on site in the power section; standard supervisions can be carried out in addition by means of the microcontroller 7; it becomes possible to transmit detailed status information; the actual values can be supplied to the control algorithm of the control unit R with minimum dead time owing to the decentralized intelligence.

As already mentioned, it is also possible for measured temperature values of the power section module L1 to be transferred to the controller R through the communications interface 2, which can be a serial interface. The following further advantages can be achieved thereby: identifiers for the type of measured value (for example, measured temperature value of IGBT current valve, fan or ambient air) can also be supplied; the controller R need not have any information on the type of sensor, for example, PT100, KTY84; if no measured temperature values are present, the temperatures can be determined through models with the characteristic values of a model algorithm being stored in the power section and either made available to the controller for calculating the algorithm, or used directly for calculation purposes in the power section. Standard inspections can also be calculated here, and detailed status information can be transmitted; and calculation of more complex supervising algorithms, for example I2t of the transistors, is rendered possible.

The intelligence in the form of the microcontroller 7 in the power section L1 can also be used to conduct diagnostics. This results in a decisive step in the direction of being able to assign the causes of error (selectivity), and thus in a reduction of the number or complexity of possible service deployments.

A non-volatile memory can be provided in the power section L1 to identify the power section L1. The nonvolatile memory, which in addition to the programs of a power section controller, stores all essential data, which can include typical values of a power section class, module-specific measurement of the parameters, serial numbers, and the like, for logging on the power section L1. The information stored in the non-volatile memory can be transmitted to the control unit R through the communications module 6, the communications link 4, and the communications module 2. It is also possible to store error data and diagnostic data in the non-volatile memory, which may lead to an improved and simplified detection of returned goods.

As a result of the distribution of the intelligence of a drive over a control unit R and one or more intelligent power sections L1, L2, L3 by using a high-performance standardized serial interface which includes the communications module 2, the communications link 4, and the communications module 6 for connecting these components, the components can be detected and diagnosed with their performance data. Furthermore, independent innovations of the components are possible because the control unit R and the power sections L1, L2, L3 are decoupled from corresponding effects on the other components.

Although the present invention has been described with several embodiments, a myriad of changes, variations, alterations, transformations, and modifications may be suggested to one skilled in the art, and it is intended that the present invention encompass such changes, variations, alterations, transformations, and modifications as are covered by the scope of the appended claims.

What is claimed is:

1. A method for networking a control unit of a drive control with at least one power section of the drive control, comprising connecting the control unit of the drive control to at least one power section of the drive control, through a digital interface with real-time capability, the at least one power section including computing capacity, and synchronizing the communication between the control unit and each of the at least one power section by means of a digital transmission protocol.

2. The method according to claim 1, further comprising the steps of determining desired digital voltage values for at least one power section in the control unit; transferring the desired digital voltage values for at least one power section to the at least one power section through the digital interface; determining drive pulses for at least one power section; controlling the drive pulses for a motor associated with at least one power section; detecting actual phase current values of the associated motor to be controlled; and transferring the actual phase current values to the control unit through the digital interface synchronously by the means of the digital transmission protocol.

3. The method according to claim 1, wherein an initialization phase for at least one power section is used to transmit a respective unique characteristic value that identifies the at least one power section.

4. The method according to claim 1, wherein an initialization phase for the at least one power section is used to transmit a respective unique characteristic value that parameterizes the at least one power section.

5. The method according to claim 1, wherein the digital interface allows bi-directional serial data transmission.

6. A power section for driving an electric drive comprising power converter valves for generating phase currents for a connected electric drive; a detector for detecting actual phase current values; a computer for generating drive signals for the power converter valves, and for digitizing the detected actual current values; and a synchronous interface for transmitting digital actual phase current values to a superordinate processing unit and for receiving digital desired voltage values for generating corresponding drive signals in the computer.

7. The power section according to claim 6, wherein the synchronous interface is configured as a bi-directional serial interface.

8. The power section according to claim 6, wherein the synchronous interface is configured as a bus system.

9. The power section according to claim 6, wherein the power converter valves are configured as a transistor bridge.

10. The power section according to claim 6, wherein the power section is configured as at least one of a converter and an inverter.

11. The power section according to claim 6, further comprising an identification means, which provides a characteristic value for unique identification of the power section through the synchronous interface.

12. The power section according to claim 11, wherein the identification means is configured as a nonvolatile memory which contains the unique characteristic value.

13. The power section according to claim 11, wherein the power section transmits a unique characteristic value to the superordinate processing unit during an initialization phase through the synchronous interface.

14. The power section according to claim 6, further comprising a detector for detecting actual temperature values of the at least one power section; a computer configured to digitize the detected actual temperature values of the at least one power section; a synchronous interface transmitting the digital actual temperature values to a superordinate processing unit.

15. A drive control, comprising an at least one power section for driving an electric drive, including power converter valves for generating phase currents for a connected electric drive; a detector for detecting actual phase current values; a computer for generating drive signals for the power converter valves, and for digitizing the detected actual current values; and a first synchronous interface for transmitting digital actual phase current values to a superordinate processing unit and for receiving digital desired voltage values for generating corresponding drive signals in the computer; a control unit, including a second synchronous interface, which receives the digital actual phase current values from the at least one power section, and transmits digital desired voltage values to the at least one power section in time with a current regulator.

16. The drive control according to claim 15, wherein the at least one power section further comprises an identification means, which provides a characteristic value for unique identification of the power section through the first synchronous interface, the at least one power section configured to transmit to the control unit the respective characteristic value for unique identification during an initialization phase through the respective first synchronous interface allowing the control unit to identify of the at least one power section.

17. The drive control according to claim 16, wherein the identification means is configured as a nonvolatile memory which contains the characteristic value for unique identification.

18. The drive control according to claim 15, wherein the at least one power section further comprises a detector for detecting actual temperature values of the at least one power section whereby the computer digitizes the detected actual temperature values, and the synchronous interface transmits the digital actual temperature values to the control unit for control purposes.

19. The drive control according to claim 15, wherein the synchronous interface is configured as a communication system which has a master-slave structure and in which the control unit is a master and the at least one power section is a slave.

20. The drive control according to claim 19, wherein the master control unit drives the at least one power section as slaves through the synchronous interface synchronously with a uniform current regulator clock.
